(19) United States
(12) Patent Application Publication
(10) Pub. No.: US 2008/0277174 A1
(43) Pub. Date: Nov. 13, 2008

(54) High-grade ethanol vehicle with fuel-cell motors and optional flexible-fuel engine

(76) Inventor: Crockett L. Grabbe, Iowa City, IA (US)

Correspondence Address: Crockett L. Grabbe, 1508 Glendale Road, Iowa City, IA, 52245, US

(21) Appl. No.: 11/801,483

(22) Filed: May 10, 2007

(51) Int. Cl. B60K 6/20

(52) U.S. Cl. 180/65.2; 903/908; 903/905; 903/906; 903/907

(57) ABSTRACT

This invention is for a hybrid vehicle operated by fuel with a high-ethanol content, which synergistically combines independent sources of ethanol power to move toward renewable and environmental-friendly fuel to replace gasoline. The vehicle combines one or more electric motors powered by Direct-Ethanol Fuel-Cells (DEFCs) using either HYPERMEC™ or a similar-type catalyst, with 2 of the 4 Preferred Embodiments provided for the ethanol hybrid also including a flexible-fuel engine. The electric motors powered by DEFCs in all the Preferred Embodiments are coupled with energy-storage systems which can independently operate the motors. For 4-wheel vehicles, all of these embodiments can be operated either in 2 or 4-wheel mode for engagement of the transmission, for either the electric motor or for the engine in Preferred-Embodiments 1 and 2, and for either of the electric motors in Preferred-Embodiments 3 and 4.

### BACKGROUND OF THE INVENTION

1. Field of the Invention

The invention relates to hybrid vehicles, with 2 of the 4 Preferred Embodiments particularly related to the form of hybrid vehicles in which a type of internal combustion engine is one of the power sources and a type of electric motor is the other power source. The invention is for hybrid vehicles especially designed for using high-grade ethanol, one component of which may be a flexible-fuel engine (internal combustion engine with special capabilities for processing fuel with high grades of ethanol), with other component(s) being electric fuel-cell motor(s), in particular electric motor(s) which are powered by Direct-Ethanol Fuel-cells (DEFCs) utilizing either HYPERMEC™ or similar catalysts that may be developed [1,2], as well as by energy-storage devices.

2. Related Prior Art

Hybrid vehicles are vehicles with more than one type of power source for the motion, with prior-art hybrids often having the capability of arbitrarily switching between power sources to operate the vehicle [3]. Prior-art examples of such vehicles use standard internal combustion engines and either battery-pack or Proton-Exchange Membrane Fuel Cells (PEMFC) motors (using a platinum catalyst). The use PEMFCs for powering the motor has significant technical barriers for cost and durability. These prior-art examples all have separate energy sources for the engine and the motor.

Flexible-fuel vehicles have been manufactured in recent years using flexible-fuel engines as their sole source of mobility (e.g. the Toyota Prius, Ford Crown Victoria, or Dodge Durango). These engines are engineered to allow fueling with high concentrations of alcohol mixed with gasoline [4]. The highest concentration of ethanol these engines are intended to handle are 85%, the content in fuel referred to as E85.

In 2005, HYPERMEC™ was invented as a catalyst enabling the processing of ethanol and ethylene glycol as well as gasoline, providing a means for Direct-Ethanol Fuel Cells [1,2].

### SUMMARY OF THE INVENTION

This invention is for a hybrid vehicle operated by fuel with a high-ethanol content, which synergistically combines independent sources of ethanol power to help satisfy a strong need for a renewable and environmental-friendly fuel to replace gasoline. The vehicle combines one or more electric motors powered by Direct-Ethanol Fuel-Cells (DEFCs) using either HYPERMEC™ or a similar-type catalyst that may be developed, with 2 of the Preferred Embodiments also including a flexible-fuel engine. The new catalyst considerably reduces the cost of the fuel cells, and the new DEFCs do not need fuel-reforming that is generally required for PEMFCs and are potentially more durable. The 4 Preferred Embodiments provided for specifically achieving this synergistic fuel transition are: (1) One DEFC-powered motor combined with a flexible-fuel engine powered with the same fuel tank (2) One DEFC-powered motor(s) combined with a flexible-fuel engine powered with separate fuel tanks (3) Two DEFC motors powered with the same fuel tank, but operating 1 at a time. (4) Two DEFC motors, both operating at the same time (intended for heavier vehicles). The electric motors powered by DEFCs in all the Preferred Embodiments are coupled with energy-storage systems that can independently operate the motors. Furthermore that last 2 Preferred Embodiments do not have the 85% ethanol restriction of flexible-fuel engines, and will be able to operate on 100% ethanol, making the fuel completely renewable and environmentally friendly. For 4-wheel vehicles, all of these embodiments can be operated either in 2 or 4-wheel mode for engagement of the transmission, for either the electric motor or for the engine in Preferred-Embodiments 1 and 2, and for for either of the electric motors in Preferred-Embodiments 3 and 4.

### DESCRIPTION OF THE INVENTION

The invention proposed is for a new type of hybrid vehicle that both uses high-grade ethanol fuel with separate entities each connecting through transmission for controlling 1 or more axles, either entity of which can be engaged to control operation of the vehicle. The separate entities referred to are a flexible-Fuel engine and 1-or-more Direct-Ethanol-Fuel-Cell (DEFC) powered motor(s) (2 Preferred Embodiments described below), or else 1-or more DEFC-powered electric motors (2 Preferred Embodiments described below). The DEFC-powered electric motors are typically closely-connected with an energy-storage system which store unused energy produced by the DEFC and can operate the electric motor independently of the DEFC. The separate entities (motors and engines) and their engagements are controlled electronically with computer logic through sensors and actuators that can ensure that only one of them can control the vehicle at a time (with the exception of embodiments in which 2-or-more entities simultaneously operate 1-or-more axles, such as in Preferred Embodiment 4 described below), with control readily transferrable between the entities. The vehicle synergistically combines 2 highly ethanol-powered entities for the first ethanol-powered hybrid.

This is the first hybrid vehicle using DEFCs to power 1-or-more motors (present in all embodiments and including not only AC motors, but DC motors when sufficiently powerful ones are available for the vehicle), as well the first hybrid to use flexible-fuel engines as in Preferred Embodiments 1 and 2 described below. Flexible-fuel engines are engines developed to process fuel with arbitrary levels of ethanol mixed with the gasoline [4], up the highest-grade ethanol fuel currently available from service stations, which is E85. E85 fuel consists of 85% ethanol and 15% gasoline [5]. The flexible-fuel engine, a component in 2 Preferred Embodiments of this invention (described below), is an internal combustion engine designed to process high-grade ethanol fuel, which uses no magnesium, aluminum, or rubber, and uses Teflon hosing. The electric motor that is present in all embodiments of this invention may powered by an economical DEFC that uses either the HYPERMEC™ catalyst invented in 2005 [1,2] or catalysts that may be similarly developed for enhancing transport of hydroxyl ions from the the cathode to the anode. These catalysts are less expensive than Platinum catalysts used previously for alcohol fuel cells, and synergistically process both components (the dominant ethanol and the smaller gasoline component) of the high-grade ethanol fuel. The electric motor may also be powered independently by an energy-storage system, which is designed to capture unused or unneeded energy from the DEFC, regenerative energy from the vehicle braking, and other available energy from the axle rotation or vehicle motion, using connected generators, with inverters as needed.

The invention provides a new hybrid vehicle which differs from the prior art with focus on:

(1) High-efficiency use of ethanol (a renewable and environmental-friendly fuel) using either both a flexible-fuel engine (particularly designed for using E85 fuel) and electric motor(s) powered by Direct-Ethanol Fuel-Cells (DEFCs), each of which drives (1 or more) separate axles of the vehicle, or else 1-or-more separate DEFC motors, each of which either drives 1-or-more separate axles, or else are combined to work in unison to drive the same set of axles. The DEFCs can operate with up to 100% ethanol, so the 2 vehicle Preferred Embodiments without the flexible-fuel engine can operate on up to 100% ethanol fuel, hence completely on renewable and environmental-friendly fuel.

(2) Minimizing the vehicle costs through the use of the lower-cost (Platinum-free) catalysts like HYPERMEC™ or similar ones that may be developed for use in the DEFC to power the electric motor, and exploitation of the simplicity it makes possible for directly and completely processing the high-grade ethanol fuel, optionally from a common fuel tank that is used in both the flexible-fuel engine and the fuel-cell motor. The catalyst is able to process both ethanol and gasoline, and tests have shown there is virtually no cross-over in the fuel cell, so that it requires no fuel-reformers. Recent tests of HYPERMEC™ at both University of Newcastle on Tyne (ENGLAND) and the CNR Institute at Florence (ITALY) have shown the ethanol molecules are completely converted to water and CO₂, so no ethanol would be expected in the exhaust emissions [6].

(3) A large-capcity energy-storage system made from a high-voltage series of any of a variety of batteries, optionally including (but not limited to) nickel-cadmium batteries, nickel-metalhydride batteries, lithium-ion batteries, lithium-solid polymer batteries, sodium-sulfur batteries, sodium-nickel chloride batteries, lithium-sulfur batteries, nickel-iron batteries, nickel-zinc batteries, zinc-bromide batteries, and nickel-hydrogen batteries, and optionally including supercapacitors. This energy-storage system is connected typically (but not necessarily) in parallel with the DEFC and stores unused energy generated by the DEFC. It also has connections to generators (along with AC/DC inverters when needed) so that it stores energy recouped from braking of the vehicle and drive-shaft rotation or other motion of the vehicle. It can be charged (through plugs) from sources external to the vehicle (such as by connecting it to household current) while the vehicle is not being driven, and can operate the motor independently of the DEFC stack. It has sensors and actuators which distributes the energy storing and charging of the system in a fast manner sufficient for efficient use as needed.

The DEFC used to power the motor will process the fuel blend in the high-grade ethanol fuel, using either HYPERMEC™ or one of similarly-developed catalysts to produce hydroxyl ions that combines with the molecules of the ethanol as well as of the gasoline component [see FIG. 1]. The exhaust products of that process of producing the power for the motor are carbon dioxide (CO₂) and water (H₂O). The exhaust CO₂ produced from the ethanol component of the fuel constitutes replacement of the CO₂ consumed in producing the ethanol (e.g. from corn), so it is “environmentally-friendly”, producing no net increase to the environment. However, the small gasoline component (15% in E85 fuel) mixed with the ethanol produces a “non-environmently-frendly” component of CO₂ (one that was not derived from the atmospher) in the emissions.

The electrical power produced by the DEFC motor(s) will be used to drive the rotors for 1-or-more axle(s) of the vehicle controlled by the transmission of the vehicle. [See FIG. 2.] The fuel cell can operate whether or not the motor is in operation or exceed the required output even if it is, and the unneed or excess energy produced is stored in the energy-storage system as electrical energy in the system's ultra-capacitors and/or in the high-voltage series of storage batteries in the storage system. The DEFC and the energy-storage system provide 2 independent sources of power for the motor.

For the cases that the vehicle also contain a flexible-fuel Engine, said engine will similarly power 1-or-more axles of the vehicle, which are separate from the ones powered by the fuel-cell engine. The electric motors and the flexible-fuel engine will have separate transmissions for control. Computer logic along with sensors and actuators will put the engine, DEFCs, energy-storage systems, motors, and transmissions under the driver's control, and ensure only 1 of the entities (engines and motors) is engaged at a time, with the exception of cases in which operate simultaneously, such as in Preferred Embodiment 4 described below. Actuators can lock the wheels through the power drive transmission, so that, for example, either the engine or the motor can be driven in 4-wheel mode as well as in 2-wheel mode for a 4-wheel vehicle.

The power output of from the ethanol fuel component in the DEFC stack is P=EₘNₛRₐK, where Eₘ is the energy of the molecular reaction, Nₛ is the number of fuel cells in the stack, Rₐ is the rate of reaction of ethanol molecules with the HYPERMEC™ or other catalyst present, and K is the efficiency of the process. The Eₘ produced from each ethanol molecule processed at the anode (with a balancing reaction at the cathode) is about 14 eV (12 electrons moving through a potential of 1.145 V) [7]. An estimate of the power output required for the motor will be taken as 100 kW, which can be compared with the automotive vehicles with PEMFC motors processing hydrogen that GM produced in the years 2000 and 2001, which similarly had a power range of 94-129 kW [8]. In order to supply the estimated required power of P=100 kW to the electric motor for driving the vehicle using a stack of 100 fuel-cells, sufficient ethanol is required for a reaction rate of on the order of Rₐ=10²¹ ethanol molecules reacting per second (0.006 of a mole of ethanol per second, where one mole of ethanol is 28 g). Assuming a low K=30% efficiency with irreversible thermodynamics and other energy losses this would correspond to an ethanol consumption rate of roughly 2 kg/hour, which is approximately 1.3 liters/hour (just over 0.3 gallon/hour). The efficiency for motors powered by the DEFC stack would be expected to increase over time, so it may exceed this estimate in DEFCs produced in later years.

In order to further determine the mileage rate this modest fueling rate produces, one would need to know the weight of the vehicle and the expected loss rate of kinetic energy to the road for the vehicle motion. However, if the engine at this power could produce a speed of only 60 miles/hour (88 km/hour), the vehicle would travel about 200 miles/gallon of ethanol (roughly 69 km/liter). These estimates show that electric motors powered by DEFCs provide a great potential for substantially reducing undesirable emissions to the environment.

### DESCRIPTION OF THE DRAWINGS

FIG. 1. Cross-sectional structure of 1 Direct-Ethanol Fuel Cell (DEFC) of the stack processing ethanol to power the electric motor, where the fuel has a high-concentration of ethanol mixed with a smaller component of gasoline. Both of these are processed with either the HYPERMEC™ catalyst or one of similar ones that may be developed for enhancing hydroxyl transport to the anode, where the reactions at the anode for both ethanol and octane (the primary component of gasoline) in the fuel are shown. The predominant (85% of the fuel for E85) ethanol reaction is balanced by 3 of the reactions shown at the cathode, whereas the less frequent octane reaction requires 12.5 of the reactions at the cathode to balance. The catalyst fosters the electrolytic transfer of OH⁻ to the anode for both reactions. The energy produced from each ethanol molecule processed is about 14 eV. Part of the H₂O is recycled from outflow at the anode back to the cathode for producing the OH⁻. The positive current produced to power the electric motor is denoted as J. For AC motors the DC current goes through an inverter to operate the motor.

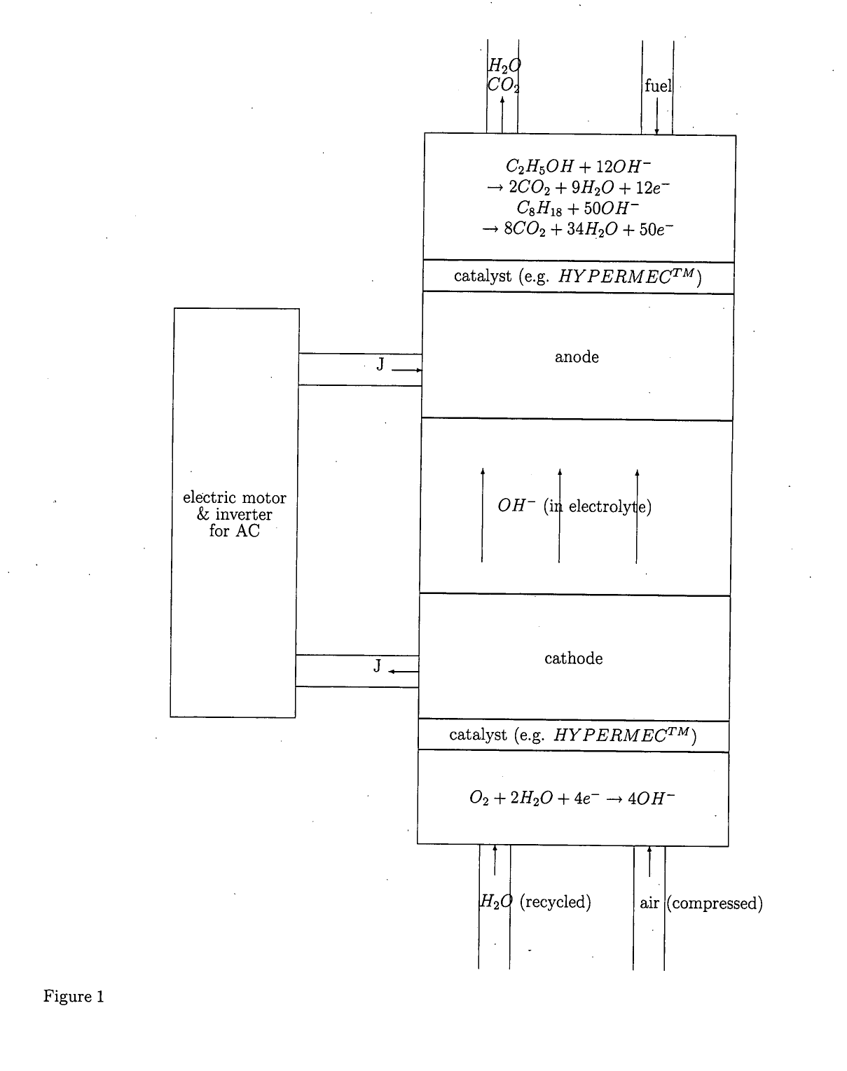

FIG. 2. An example of the DEFC stack (showing 10 fuel cells) that powers the electric motor, its fuel and oxygen compressor inputs, the motor and its controller, and its connection with the transmission and drive. This case shows the motor and an energy-storage system (using ultra-capacitors and/or high-voltage storage batteries) in parallel with the fuel-cell stack. The electric motor can be turned off while the fuel-cell operates and store energy in the system. Furthermore, with energy stored, the fuel-cell operation can be turned off while the electric motor operates. These options will be electronically under the driver's control through the computer logic with the sensors and actuators. The braking system for the wheels (represented by the single box in the diagram) are mechanically connected to the electrical generator, so that when brakes are applied the braking resistance load drives current, which charges batteries and/or supercapacitors in the energy-storage system.

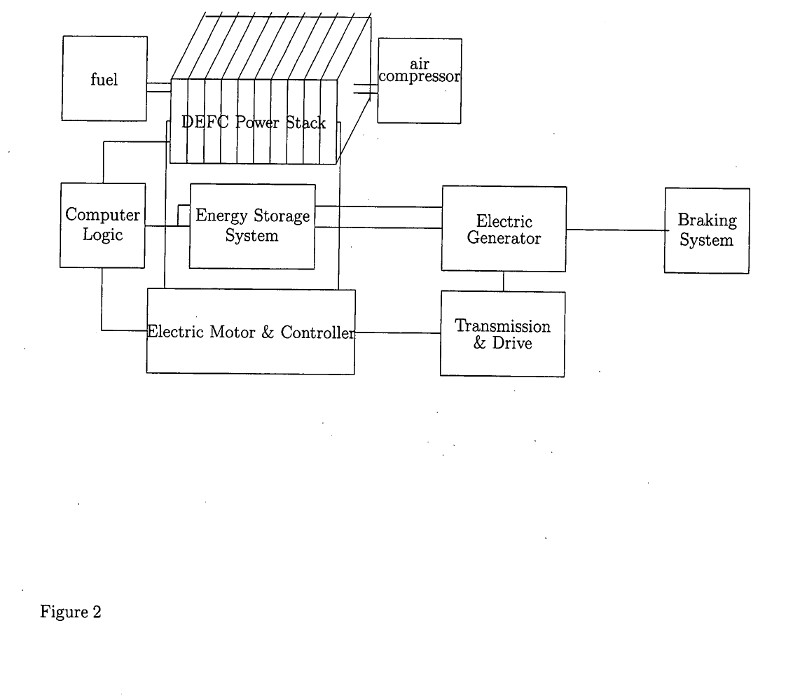

FIG. 3. Flexible-fuel engine and DEFC motor connections to the fuel tanks for Preferred Embodiment 1 in which the both the motor and the engine can be fueled by the same tank. Dielectric sensors and actuators control the shutters, which open the tanks according to which entity the driver chooses to operate, with the shutters typically (but not necessarily) present in the connections from the principal (high-grade ethanol) fuel tank to the engine and the motor to help ensure they operate in a mutually exclusive manner. When the DEFC-powered motor is engaged the emissions are primarily low emissions of environmental-friendly CO₂ and H₂O. When the flexible-fuel Engine is operated sensors detect the concentration of ethanol in the fuel to the engine, from which the Engine Control Unit regulates timing for the engine's fuel injectors and spark plugs. (Alternatively, the engine may use the oxygen sensors in the exhaust manifolds.) The auxiliary tank allows the use of fuel with a lower-concentration of ethanol in the flexible-fuel engine (useful when high-grade ethanol fuel is not readily available). Whether the engine or the electric motor is driving the vehicle, vehicle drive-shaft rotation drives a generator (and inverter if needed) which can store energy in the energy-storage system, and can also tap energy from it to start the engine. Note that in the example of just 1 motor as shown here, the vehicle in this embodiment can by powered from 3 independent sources: the engine, the fuel-cell stack, and the energy-storage system, with the latter 2 devices operating the electric motor.

FIG. 4. Flexible-fuel engine and fuel-cell motor connections to the fuel tanks for Preferred Embodiment 2 in which the both the motors and the engine are fueled by separate fuel tanks. The driver chooses to operate either entity through actuator control, which is typically (but not necessarily) used to ensure fuel to the motor and fuel the engine are mutually exclusive. When the flexible-fuel engine is operated a sensor detects the concentration of ethanol in the fuel to the engine, from which the Engine Control Unit regulates timing for the engine's fuel injectors and spark plugs. (Alternatively, the vehicle may use an oxygen sensor in the exhause manifold.) As in FIG. 3, vehicle drive-shaft rotation drives a generator (and inverter if needed) which can store energy in the energy-storage system, as well as tap energy from it to start the engine. As in FIG. 3 this example can be powered by 3 indepenent sources (engine, DEFC stack, and energy-storage system).

FIG. 5. Fuel-cell motors connections to the fuel tanks for Preferred Embodiment 3 in which only fuel-cell motors are present (but no engine). An example is shown for 2 separate fuel-cell motors which are fueled by the same tank, and which both store energy in the same storage location. Dielectric sensors and actuators control shutters, which open the tanks according to which motor the driver chooses to operate, with the shutters typically (but not necessarily) operating mutually exclusively for lighter vehicles. Embodiment 3 shown has 4 independent forms of power for the vehicle: the DEFCs operating each motor and the energy storage system operating each motor, and these are all under the driver's control through computer logic with sensors and actuators. Transmission present allows each motor to engage 1-or-more axle(s) of the vehicle. A variation of this in which there are no shutters present and both motors operate at the same time, a version intended for heavier vehicles, is Preferred Embodiment 4. For this heavier-vehicle variation there are still independent sources for the power for the motor, and the presence of dual motors will allow a limited movement of the vehicle to a repair station if one of the motors fails.

### DESCRIPTION OF THE PREFERRED EMBODIMENTS

### EXAMPLE 1

### DEFC Motor and Flexible-Fuel Engine Fueled Separately from the Same Tank According to the Present Invention

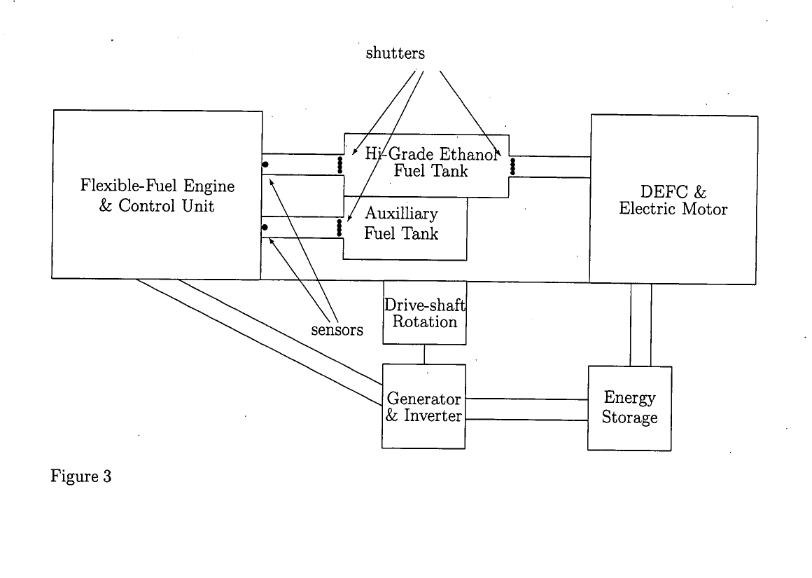

This version has a common fuel tank for high-grade ethanol either for the flexible-fuel engine or for the DEFC-powered motor. It typically (but not necessarily) uses a shutter that is closed on one side of the tank when the other side is open. An auxillary tank to the flexible-fuel engine can be used for lower-grade mixtures of ethanol and/or gasoline specificaly for the engine, such as at times when high-grade ethanol is not available. The flexible-fuel engine uses sensors from either tank to detect the concentration of ethanol in the fuel to the engine, from which the Engine Control Unit regulates timing for the engine's fuel injectors and spark plugs. [See FIG. 3.]

Each of the 2 entities (engine and electric motor) has its own transmission (not shown), and each of these transmissions can control 1-or-more axle(s) of the vehicle. As an example, either transmission can engage both axles or 4-wheels for a 4-wheel vehicle.

This Preferred Embodiment is the first invention exploiting fueling an engine and a DEFC-powered motor from the same high-grade ethanol fuel tank. It exhibits the unexpected benefits that arise from synergism of using a hybrid vehicle with both a flexible-fuel ethanol engine and a DEFC-powered motor, which can both be run from same tank on high-grade ethanol fuel. No previous hybrid-vehicle exhibits similar synergism.

### EXAMPLE 2

### DEFC Motor and Flexible-Fuel Engine Fueled from 2 Separate Tanks According to the Present Invention

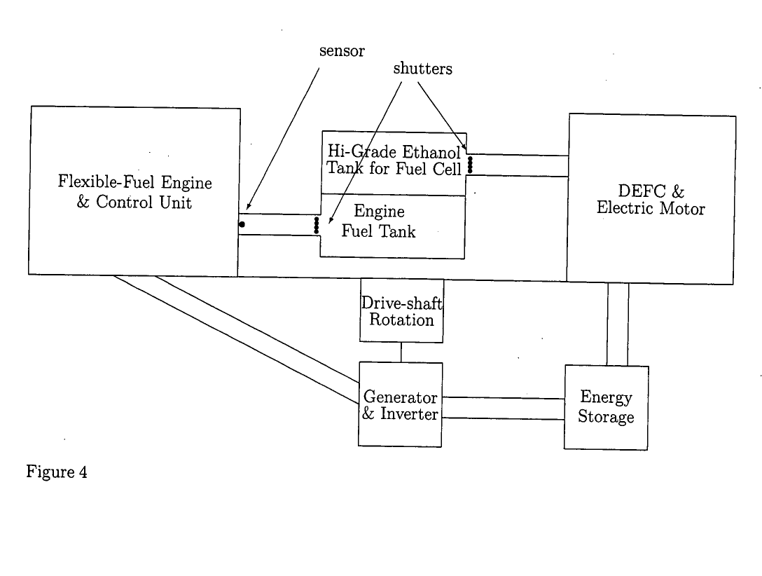

This version has separate fuel tanks fueling the flexible-fuel engine and the DEFC-powered motor. The engine fuel tank can process any combination mixture of gasoline and ethanol, whereas the DEFC-powered motor fuel tank generally uses high-grade ethanol. Like Preferred Embodiment 1, the flexible-fuel engine uses a sensor from its tank to detect the concentration of ethanol in the fuel to the engine, from which the Engine Control Unit regulates timing for the engine's fuel injectors and spark plugs. [See FIG. 4]

Like Preferred Embodiment 1, each of the 2 entities (engine and electric motor) has its own transmission (not shown), and each of these transmissions can control 1-or-more axle(s) of the vehicle. For example, either transmission can engage both axle(s) (4-wheels) in a 4-wheel vehicle. Note also that one restriction is lifted from Preferred Embodiment 1 in Preferred Embodiment 2: the use of separate tanks for the motor and engine makes it possible to use up to 100% ethanol to operate the DEFCs when that becomes available, so the motor can operate in a purely environmentally-friendly manner.

### EXAMPLE 3

### 2 DEFC Motors Both Fueled from 1 Tank According to the Present Invention

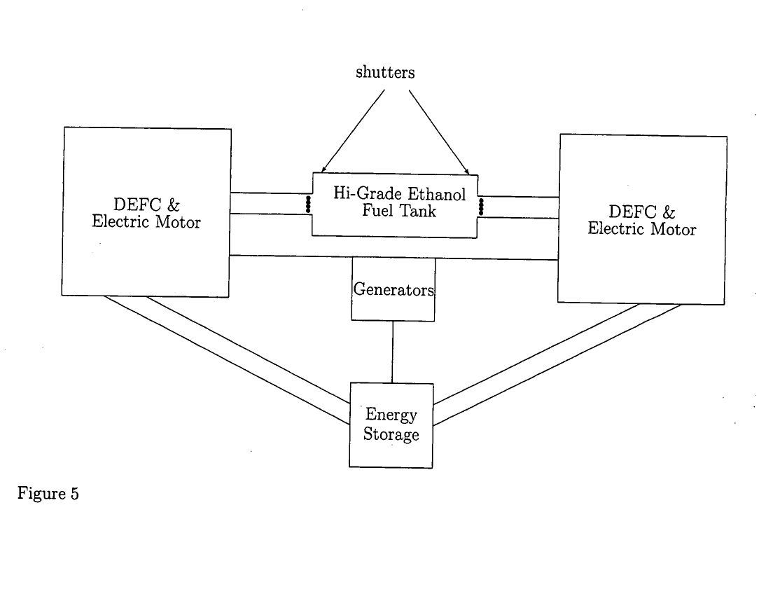

This version has a common fuel tank for high-grade ethanol for either of the 2 DEFC-powered motors. Preferred Embodiment 3 of this invention has 2 fuel-cell motors run directly with high-grade ethanol from a common fuel tank, with variations of this form using separate fuel tanks for the 2 motors. The vehicle operates on only one DEFC-powered motor at a time, and will typically (but not necessarily) use shutters that are closed on one side of the tank when the other side is open. This embodiment comprises the first hybrid allowing a (DEFC-powered) motor to run 1-or-more axle(s) (e.g. the front-wheel drive of a 4-wheel vehicle), a back-up motor to run 1-or-more separate axle(s) (e.g. the back-wheel drive of a 4-wheel vehicle), and transmission to engage either drive into 4-wheel mode through a powertrain connecting the axles. The advantage of having 2 motors is that when the DEFC-powered motor that is in use suddenly develops a major problem in operation, the driver is not stranded, but can switch the vehicle to the other motor to continue travelling, and loses nothing in the operability of the vehicle. The driver can run either motor from either the fuel tank or the energy-storage system [see FIG. 5].

It is anticipated that Preferred Embodiment 3 will be first be built after DEFC motors are more well-developed than when Preferred Embodiments 1 and/or 2 are first built, so that the DEFC technology has progressed to make the electric motors the most reliable for all types of driving, and the engine ceases to be necessary. These vehicles can be made considerably lower weight, since the motors will be notably lighter than an engine. Furthermore, the high-grade ethanol fuel can exceed the ethanol percentage in E85. It will be capable of using up to 100% ethanol fuel whenever it becomes available. Then the vehicle emissions can be purely environmentally-friendly, and the power the motors provide will take the vehicle to notably greater distances than was previously achievable with Embodiments 1 and 2 because of the the anticipated weight difference between DEFC-powered motors and flexible-fuel engines. This will be the first pure-ethanol vehicle that is anticipated to travel several hundred miles per gallon of fuel.

### EXAMPLE 4

### 2 DEFC Motors Operating Together According to the Present Invention

The adequacy of Preferred-Embodiment-3 vehicles depends on the size of the vehicle and load being carried. Sufficiently-heavy vehicles may make it advantageous to use both motors (e.g. in trucks). The 2 motors combine the power they produce to drive 1-or-more axle(s) (set by the transmission) and supply energy to the energy-storage system. The form is much like that in FIG. 5, except that shutters are not present, and an option is to also use separate fuel tanks for the engines. These vehicles may also have additional axles, and these additional axles may be also engaged with appropriate transmission.

In Preferred Embodiment 4 the DEFC stacks and the energy-storage system provide independent sources for the power for the motors, which is all under the driver's control through computer logic with sensors and actuators. With 2 separate motors, if one of the motors fails it will generally be possible to move the vehicle on its own to a repair station with the power of the working motor. Like Preferred Embodiment 3 the vehicle can be fueled on pure ethanol, making it completely “environmentally-friendly”.

### REFERENCES

1. “Acta doubles fuel cell catalyst power output,” Fuel Cells Bulletin, Volume 2006, January 2006, p. 8.

2. “A disruptive approach to catalysis,” Fuel Cell Review, Volume 3, February-March, 2006, p. 26-27.

3. C. M. Jefferson and R. H. Barnard, Hybrid Vehicle Propulsion (WIT Press, Southampton, UK, 2002).

4. National Ethanol Vehicle Coalition, 2006 Purchasing Guide for Flexible-fuel Vehicles [availble online at www.E85Fuel.com].

5. Handbook for Handling, Storing, and Dispensing E85 (U.S. Department of Energy, April, 2006) [available online at www.E85fuel.com].

6. “Acta's green ethanol fuel cell wins academic acclaim,” FuelCellWorks.com news published May 24, 2006, online at www.fuelcellworks.com/Supppage5258.html.

7. Xiaomong Ren, “Acta and HYPERMEC: A Breakthrough Catalyst Technology,” Nov. 13-17, 2006 Fuel Cell Seminar at Honulu, Hi., online at www.fuelcellseminar.com

8. Gregor Hoogers, Fuel Cell Technology Handbook (CRC Press, Boca Raton, Fla., 2003), chap. 10.

1. The benefits of the provisional patent application No. 60/808,230 mailed to the USPTO on May 23, 2006 (filing date indicated as May 25, 2006) under like title, including the specification and drawings contained therein, which serves as a placeholder for this non-provisional utility patent application.

2. A hybrid vehicle designed to use high-grades of ethanol fuel for sizably reducing the atmospheric pollution created relative to similar gasoline-fueled vehicles, comprising a synergistic combination of either a flexible-fueled internal combustion engine along with 1-or-more electric motor(s) powered by a stack of Direct-Ethanol Fuel-Cells (DEFCs), or else 1-or-more electric motor(s) which are powered by a stack of DEFCs or independently with the energy-storage systems coupled with the DEFCs, with the entities (engines and motors) for either case fully capable of operating on high-grade ethanol fuel, and with the electric motors including both AC motors and DC motors that are developed with adequate power capabilities to operate the vehicle.

3. The hybrid vehicle of claim 2, wherein the electric motor(s) are powered by a stack of Direct-Ethanol Fuel Cells (DEFCs) using either the HYPERMEC™ catalyst or similar catalysts that may be developed to help transfer hydroxyl ions from the cathode to the anode, which synergistically extract power from both from the ethanol component as well as from the gasoline component of the high-grade ethanol fuel.

4. The hybrid vehicle of claim 2, wherein each electric motor powered by DEFC-power sources produces rotational torque and drives 1-or-more axle(s) of the vehicle, with a transmission capable of engaging 1-or-more axles for driving by the motor, and sensors, actuators, and computer logic for controlling the electric motor, fuel cell, and transmission.

5. The hybrid vehicle of claim 2, wherein the electrical energy produced by the DEFC stack that is not used for operation of the motor is stored in a system for energy-storage, also referred to as an energy-storage device, consisting of a high-voltage (several hundred volts or more) series of storage batteries, optionally including but not limited to nickel-cadmium batteries, nickel-metalhydride batteries, lithium-ion batteries, lithium-solid polymer batteries, sodium-sulfur batteries, sodium-nickel chloride batteries, lithium-sulfur batteries, nickel-iron batteries, nickel-zinc batteries, zinc-bromide batteries, nickel-hydrogen batteries, and supercapacitors, with said energy-storage system generally (but not necessarily) electrically parallel to the electric motor and DEFC power source.

6. The energy-storage system or device of claim 5, which is capable through connection with generators of regenerating much of the energy expended in braking as well as produced in shaft-rotation or other operation of the engine or motor, is capable of being fully charged externally through plug connections when the fuel-cell system is not operating (including connection to household current), is capable of producing needed power and operating the electric motor independently of the DEFCs, and has sensors and actuators with computer logic for its control and interaction with the electric motor, which distributes the energy storage and charging of the devices in a fast manner sufficient for efficient use as needed.

7. The hybrid vehicle of claim 2 for the case that it uses a flexible-fueled engine in addition to the DEFC-powered motor(s), wherein the flexible-fueled engine is powered by the high-grade ethanol fuel that is synergistically supplied from the same fuel tank as the fuel powering the electric motor through the stack of DEFCs, with optional shutters preventing both from being fueled at the same time and optionally also including an auxilliary tank for separately supplying lower-grade ethanol to the flexible-fuel engine, which produces rotational torque, has transmissions capable of engaging 1-or-more axle(s) of the vehicle for driving by the flexible-fueled engine or for driving by the electric motor independently, and has sensors, actuators, and computer logic for controlling the flexible-fuel engine, electric motor, DEFCs, shutters, and transmissions.
(Preferred Embodiment 1)

8. The hybrid vehicle of claim 2 for the case it uses a flexible-fueled engine in addition to the DEFC-powered motor(s), wherein the flexible-fuel engine is powered by the ethanol fuel supplied through a separate tank from the DEFC-powered motor(s) so the motor(s) can operate on up to 100% ethanol, the entities (engine and motor) produce rotational torque to drive 1-or-more axle(s) of the vehicle and have transmissions capable of independently engaging axle(s) operated by the flexible-fuel engine or axle(s) operated by the electric motor, and computer logic connected with sensors and actuators controls the flexible-fuel engine, electric motor, fuel cell, and transmissions electronically.
(Preferred Embodiment 2)

9. The hybrid vehicle of claim 2 for the case that it synergistically combines 1-or-more electric motors without an engine, wherein the vehicle can operate on up to 100% ethanol fuel, each motor of which is powered by a stack of Direct-Ethanol Fuel-Cells (DEFC) and/or the energy-storage system of claims 5 and 6 and can operate on up to 100% ethanol, each of which produces rotational torque and with transmission drives 1-or-more separate axles of the vehicle, and each motor of which is controlled electronically with computer logic through sensors and actuators.

10. The hybrid vehicle of claim 9, in which 2-or-more electric motors each powered through a stack of DEFCs, are each powered by the high-grade ethanol fuel that is either supplied from the same fuel tank with optional shutters preventing both from being fueled at the same time or from separate fuel tanks, or independently by the energy-storage system of claims 5 and 6, each of which produces rotational torque and through transmission drives 1-or-more separate axles of the vehicle, and each of which can be controlled electronically with sensors, actuators, and computer logic.
(Preferred Embodiment 3)

11. The hybrid vehicle of claim 9, in which 2-or-more electric motors are powered at the same time by a stack of DEFCs fueled by a common or separate fuel tanks and/or 1-or-more energy-storage systems of claims 5 and 6, and which combine the power they produce for rotational torque and through transmission drive 1-or-more separate axles of the vehicle, and can be controlled electronically by computer logic through sensors and actuators.
(Preferred Embodiment 4)
